(19) United States
(12) Patent Application Publication
(10) Pub. No.: US 2012/0244491 A1
(43) Pub. Date: Sep. 27, 2012

(54) DEVICE AND METHOD FOR TEETH BRIGHTENING

(76) Inventors: Remigio Piergallini, Grottammare Ascoli Piceno (IT); Nikolaos Loupis, Athens (GR); Shipra Rastogi, Laval (CA)

(21) Appl. No.: 13/069,341

(22) Filed: Mar. 22, 2011

(51) Int. Cl. A61C 17/00

(52) U.S. Cl. 433/80; 433/216

(57) ABSTRACT

The disclosure relates to a device for applying a tooth brightening composition to a tooth that includes a reservoir fluidly connected to an applicator, wherein the applicator has a frictional stress value sufficient to cause mechanical displacement of a biofilm present on a surface of the tooth. Alternatively or in combination with the above device, the applicator contains pores having a diameter of 0.1-1000 μm.

### BACKGROUND

Tooth appearance-enhancing products are applied in different ways. A common technique is to cast an impression of a person's teeth and provide a tray of the shape of this impression. A person then only needs to add a whitening composition to the tray and to apply the tray to his/her teeth. This is left in place for a period of time and then removed. After a few treatments the teeth gradually whiten. Another technique is to use a strip that has a whitening composition on one surface. This strip is applied to a person's teeth and left in place for about 30 minutes. After several applications the teeth are gradually whitened. Yet another technique is to apply a whitening composition to teeth using a small brush. This brush is repeatedly dipped back into the container during the application of the tooth whitening composition to ones teeth. After a few treatments the teeth gradually whiten. However, these alternatives have the disadvantage in that they are cumbersome to use. Therefore, there is a need for an application device for a tooth whitening composition, which is easy to use, easy to store, easy to carry, and at the same time allows effective mechanical removal of a biofilm to facilitate the tooth whitening process.

### SUMMARY OF THE INVENTION

Disclosed herein is a device and method for applying a brightening composition to a tooth. Preferably, the device applies a certain frictional stress upon a tooth to be brightened. More preferably, the device applies a frictional stress value that allows mechanical displacement of a biofilm present on the surface of a tooth. Even more preferably, the device applies a frictional stress value that allows mechanical displacement of a pellicle layer present on the surface of a tooth, but does not induce damage to the tooth enamel. Also disclosed herein are teeth brightening compositions for use in conjunction with the device.

In some embodiments, the device comprises a reservoir fluidly connected to an applicator and the applicator has a frictional stress value sufficient to cause mechanical displacement of a biofilm present on a surface of the tooth. The applicator may comprise pores having a diameter of 0.1-1000 μm, often in conjunction with the above-indicated frictional stress value. A brightening composition may be disposed in the reservoir. The device may comprise an activator configured to dispense the tooth brightening composition from the reservoir onto an exterior surface of the applicator.

In some embodiments, the exterior surface of the applicator has a surface area of up to 4-100 mm².

In some embodiments, the applicator comprises a sponge.

In some embodiments, the brightening composition is present in an amount ranging from 2-6 ml.

In some embodiments, the brightening composition comprises a source of peroxide.

In some embodiments, the brightening composition includes hydroxyapatite, such as where the hydroxyapatite has a particle size ranging from 10 to 200 nm.

In some embodiments, the applicator comprises a sponge and the sponge may include pores of sufficient diameter and connectivity for the hydroxyapatite to be transported through the sponge onto an exterior surface of the sponge.

In some embodiments, the invention relates to a method for teeth brightening. The method may comprise the steps of a) providing a brightening composition disposed within a cylindrical reservoir, the cylindrical reservoir being fluidly connected to an exterior surface of an applicator having a frictional stress value sufficient to cause mechanical displacement of a biofilm present on a surface of the tooth, or comprising pores having a diameter of 0.1-1000 μm, or both, b) dispensing the brightening composition through the applicator onto the exterior surface of the applicator, and c) applying the brightening composition onto a tooth.

In some embodiments, the brightening composition is applied manually by rubbing the applicator onto a tooth and exerting pressure towards the tooth.

In some embodiments, manually rubbing the applicator onto the tooth and exerting pressure towards the tooth causes mechanical displacement of a biofilm from the tooth.

In some embodiments, the device is used for simultaneously brightening a tooth and removing a biofilm from a surface of a tooth.

### BRIEF DESCRIPTION OF THE DRAWINGS

FIG. 1 shows a device for applying a brightening composition to a tooth.

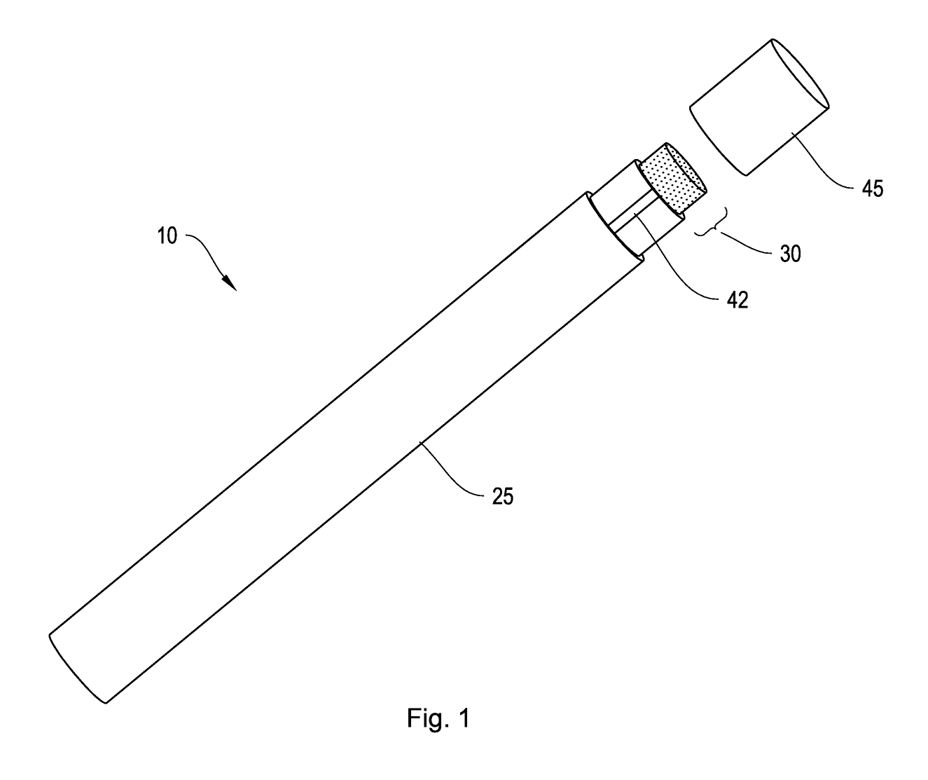

FIG. 2 shows a device for applying a brightening composition to a tooth, wherein the device has an applicator comprising a sponge.

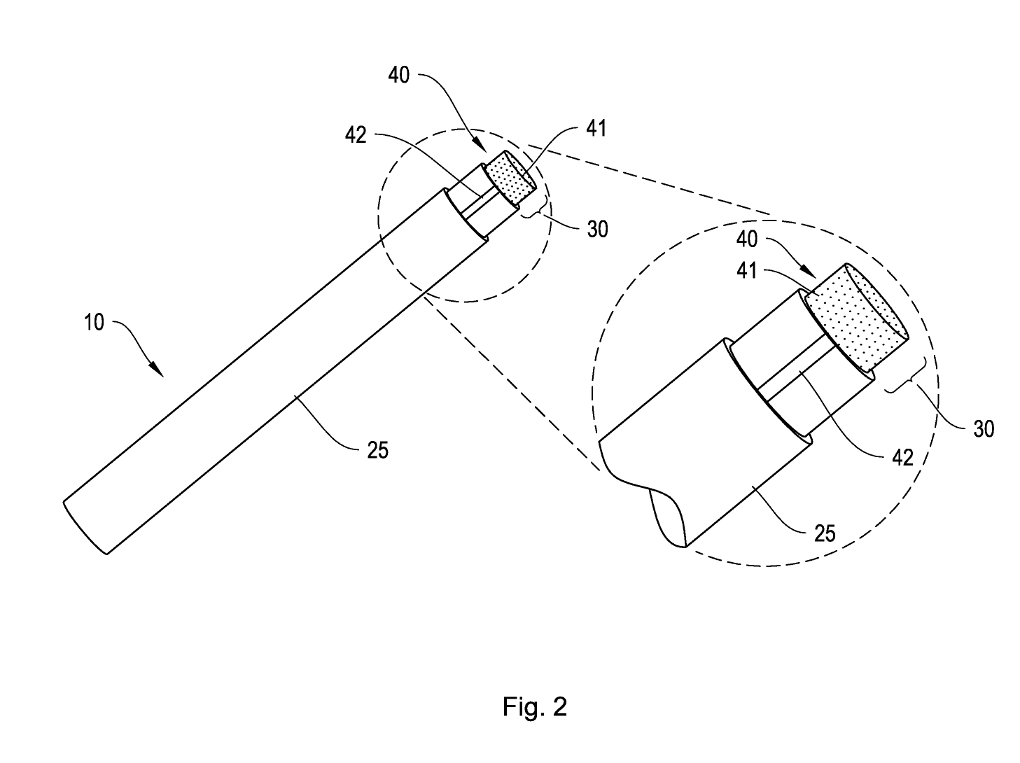

### DETAILED DESCRIPTION

### Application Devices

Described herein is a device 10 and method for applying a brightening composition to a tooth. Preferred devices comprise a reservoir 25 fluidly connected to an applicator 30. Preferably, the applicator is optimized with regard to its mechanical performance so as to induce a certain frictional stress upon a tooth. An advantageous choice of frictional stress allows effective tooth brightening, but without damaging the enamel or another portion of the tooth or gums. However, the frictional stress should be sufficient to mechanically displace a biofilm and/or pellicle layer (partially or completely) from the surface of a tooth. “Pellicle” as used herein is a layer of salivary glycoproteins that adhere to the surface of a tooth. “Biofilm” as used herein is a substance that adheres to the surface of the tooth or the pellicle layer, and may include additional components, for example substances excreted from bacteria. For example, a biofilm may include a sessile community of cells that may be microbioally derived and that are attached to a substrate or to each other. These adherent cells are often embedded in a matrix of extracellular polymeric substances that they have produced, and that exhibit an altered phenotype with respect to growth rate and gene transcription. Inadequate removal of biofilm and pellicle layer from the surface of a tooth often results in the development of a yellowish substance more commonly known as dental plaque.

The device 10 places an applicator 30 in contact with the surface of a tooth and delivers a tooth brightening composition through the applicator 30 onto the surface of a tooth.

The device 10 preferably has a reservoir 25 for storing the brightening composition and an applicator 30 that is fluidly connected to the reservoir 25 via a feeder 42. The device 10 may be portable and in the shape of a pencil, pen or liquid stick. In one embodiment, the device 10 includes more than one applicator 30 that may be removably engaged with the device 10. In an embodiment wherein the device 10 is a shaped like a pen or a pencil, the applicator 30 may be retractable. The brightening composition described herein may be housed directly within the reservoir 25 in the device 10 or may be supplied in a removable cartridge (not shown) within the reservoir 25 that may be replaced or refilled. The device may also comprise a cap 45.

It is believed that the performance of the applicator 30 with regards to tooth brightening is enhanced by the friction or abrasion induced by the applicator 30 upon a tooth. The friction or abrasion induced by the applicator 30 upon a tooth can be defined in terms of frictional stress. The frictional stress value can be defined as the force exerted upon a reference surface per unit area of real contact, which is expressed as σ=T/A=μN/A. In this equation, T is the tangential force, A the area of contact, μ the coefficient of friction, and N the vertical force.

Without being bound by theory, it is believed that the frictional stress of an applicator 30 is of particular importance, as it indicates the efficiency with which the mechanical energy provided by the user is transferred to the surface of a tooth. The frictional stress can cause mechanical displacement of biofilm. When an applicator has a low frictional stress value, the energy supplied by the user is dissipated in other ways, for example, through the applicator itself, resulting in the applicator deforming.

Frictional stress values greater than 0.001 N mm⁻² are advantageous. More preferably, the frictional stress values are from 0.001-0.01 N mm⁻², 0.01-0.1 N mm⁻², 0.1 to 0.2 N mm⁻², 0.2-0.3 N mm⁻², 0.3-0.4 N mm⁻², 0.4-0.5 N mm⁻², 0.5-0.6 N mm⁻², 0.6-0.7 N mm⁻², 0.7-0.8 N mm⁻², 0.8-0.9 N mm², or 0.9-1 N mm². In certain embodiments, the frictional stress values may be from 1-1.5 N mm⁻², 1.5-2 N mm⁻², or even from 2-2.5 or 2.5-3 N mm⁻².

The frictional stress value of an applicator 30 may be measured using methods known in the art. One example uses a Plint dual axis reciprocating rig (such as model TE75R, MRPRA RUBBER CONSULTANTS). The device 10 is clamped to the load arm of the reciprocating rig and the angle of the device relative to the reference surface is adapted to maximize the contact area of an exterior surface of the applicator 30. The clamping arrangement should be set to provide a consumer realistic normal force, N, on the applicator 30 of about 3 N. The coefficient of friction is then measured between the applicator 30 and a reference surface that is similar to the surface of a tooth. The applicator 30 is measured wet using a brightening composition as given in Example 1. The coefficient of friction is measured over the central 10 mm of four traverses of 20 mm in both the forward and reverse direction at a speed of 1 mm s⁻¹ and an average value calculated. Measurements with the applicator 30 in final measuring position are repeated three times to check reproducibility.

In some embodiments, the applicator 30 comprises a sponge 40. The sponge 40 includes pores 41 that are fluidly connected to a feeder 42 which receives the brightening composition from reservoir 25. Preferably, the sponge 40 is comprised of pores 41 having a mean diameter of about 0.1-1000 μm. More preferably, the pores have a mean diameter of about 0.1-100 μm, 100-200 μm, 200-300 μm, 300-500 μm, 500-750 μm or 750-1000 μm.

The sponge 40 may be made of synthetic or man-made or natural materials such as felt, foam, polyethylene, nylon, etc. Preferably, the sponge 40 is made of a material resistant to peroxide-induced corrosion. A suitable exemplary material for the sponge 40 is nylon such as flocked nylon. In some embodiments, the sponge 40 is optimized with regard to having pores 41 of sufficient diameter and connectivity for particles (e.g., hydroxyapatite particles, as described below) in the brightening composition to be transported through the pores 41 onto an exterior surface of the applicator 30. BrightOne (www.blancone.it) sold by International Dental Supply includes a sponge having the above described characteristics.

The contact area between the exterior surface of the applicator 30 and a surface of a tooth preferably is from 0.25-400 mm², 4-100 mm², or 9-25 mm². Such a contact area ensures optimal mechanical removal of biofilm and allows for efficient application of the brightening composition onto the surface of a tooth.

Measurements of the contact area of the exterior surface of the applicator 30 can be carried out with a dry applicator 30. The dry applicator 30 is wetted by pressing it against a pad containing a brightening composition and then clamping the device 10 to the load arm of a plint dual axis reciprocating rig (such as model TE75R, MRPRA RUBBER CONSULTANTS). A mark on a contact surface that is representative of the contact area of the exterior surface of the applicator 30 is obtained by controlled lowering and rising of the plint load arm towards and away from the reference surface. The angle of the device relative to the reference surface is adapted to maximize the contact area between the applicator 30 and the reference surface. The contact time should be approximately 1 s while a normal load of about 3 N should be applied on the application device. The contact area can then be calculated from the mean length and width of the mark determined using a magnifying lens with a graticule. Measurements with the applicator 30 in final measuring position are repeated three times to check reproducibility.

The device 10 may dispense the brightening composition from the reservoir 25 onto an exterior surface of the applicator 30 through the feeder 42 via capillary action, such as in a flow through pen, or by exerting pressure on the applicator 30 by pushing the device 10 onto a surface of a tooth, or via an activator, such as a mechanical piston with a click mechanism, a twist button and ratchet mechanism, or a push button mechanism, or through a vacuum method of ejection, or through other mechanical means that transfer the composition from the reservoir 25 to an oral cavity surface in need of treatment. The activator may be positioned on a first end or side wall of the device 10.

In certain embodiments, the device has an activator comprising a push button. With the push button activator, the user pushes the button located on a first end or side wall of the device 10, which causes the transfer of the composition from the reservoir 25 through the feeder 42 and onto the exterior surface of the applicator 30. More preferably, push button activator has an arrangement that allows partitioning of the brightening composition. This can be achieved, for example, via a catch arresting mechanism connected to the push button activator. From the sound of the catch upon actuating the push button activator, the user is able to recognize that a single dose of the brightening composition has been dispensed onto the exterior surface of the applicator 30.

Once the composition is positioned onto the exterior surface of the applicator 30, a user applies the composition to a tooth surface by manually rubbing the applicator 30 onto the tooth and exerting pressure towards the tooth. Preferably, manually rubbing the applicator 30 onto the tooth and exerting pressure towards the tooth causes mechanical displacement of a biofilm from the tooth surface.

A set of instructions can be provided to the user to describe how to apply the composition from the device 10 onto the teeth and/or gums.

In certain embodiments, the reservoir 25 is made of peroxide-resistant materials. In one embodiment, the reservoir 25 is made from fluoropolymers, polypropylene, polyethylene, or other such polymers that are compatible with the ingredients of the composition of the present invention.

### Brightening Compositions

The brightening composition used herein is comprised of a gel carrier and at least one brightening agent dispersed throughout the gel carrier. The brightening agent may be dissolved in the gel carrier or simply dispersed homogeneously in the carrier as an insoluble suspended solid particulate.

The brightening agent may comprise a peroxide source. Hydrogen peroxide is a powerful oxidizing agent. Typically, the concentration of hydrogen peroxide in the present composition is from about 0.001-10% by weight of the composition, such as 1-7% or 4-6%. Urea hydrogen peroxide (also known as urea peroxide, carbamide peroxide or percarbamide) may also be used. Typically, the concentration of urea peroxide in the present composition is from about 0.003-30% by weight of the composition, such as about 1-25%, 10-20% or 13-17%.

The gel carrier may contain any number of ingredients that increase the viscosity of the composition and may be present in an amount ranging from about 35-95%, or 45-70%, or 55-65% by weight of the composition. In certain embodiments, sufficient gel carrier is added to obtain a brightening composition having a viscosity of about 10,000 to 200,000 cps, or about 30,000 to 150,000, or 50,000 to 120,000. The gel carrier may comprise one or more polymers. Preferred polymers are high molecular weight polymers of acrylic acid such as Carbopol®. The gel carrier may also include cellulose derivatives (such as hydroxyethyl cellulose, carboxymethyl cellulose sodium, and methyl cellulose), gums (such as sodium alginate, carrageenan, xanthan gum, tragacanth gum, acacia gum, jellan gum, and native jellan gum), synthetic binders (such as polyvinyl alcohol, carboxyvinyl polymer, polyvinyl pyrrolidone, propylene glycol and polyethylene oxide), natural polyols (such as glycerin, mannitol, sorbitol and maltitol) and inorganic binders (such as silica gel, aluminum silica gel, bee gum, and Laponite). For example, the gel carrier may contain a polymer in combination with a synthetic binder and/or a natural polyol, such as 12-18% synthetic binder (e.g., propylene glycol), 40-50% natural polyol (e.g., glycerin), and 0.5-4% of polymer (e.g., Carbopol).

In some embodiments, the brightening composition comprises flavoring agents. Flavoring agents that are useful include essential oils as well as various flavoring aldehydes, esters, alcohols, and similar materials. Examples of the essential oils include oils of spearmint, peppermint, wintergreen, sassafras, clove, sage, eucalyptus, marjoram, cinnamon, lemon, lime, grapefruit, and orange. Also useful are such chemicals as menthol, carvone, and anethole, and synthetic flavors like Evercool, and derivatives of cyclic alpha-keto enamines. Of these, the most commonly employed are the oils of peppermint, spearmint and wintergreen. The flavoring agent is incorporated in the brightening liquid composition of the present invention at a concentration of about 0.05 to about 2%, or preferably about 0.1 to about 0.5% by weight of the composition. A sweetening material may also be employed as a complement to the flavoring material. Suitable sweetening agents are water soluble and include sodium saccharin, sodium cyclamate, xylitol, perillartien, D-tryptophan, aspartame, dihydrochalcones and the like.

In some embodiments, the brightening composition comprises a brightening particulate. The brightening particulates may comprise a form of calcium phosphate. The calcium phosphate may have a structure selected from tetracalcium phosphate, amorphous calcium phosphate, alpha-tricalcium phosphate, beta-tricalcium phosphate and hydroxyapatite (Ca₅(OH)(PO₄)₃). The calcium phosphate may be a substantially aqueous insoluble calcium phosphate and non-crystalline, poorly crystalline or crystalline form such as, for example, crystalline hydroxyapatite. Preferably, the brightening composition includes nanoparticles of hydroxyapatite.

Hydroxyapatite has a similar physical structure as tooth enamel, and thus has a strong affinity to the tooth enamel surfaces, resulting in the hydroxyapatite particulates imparting a “natural” white appearance to the enamel surface. The hydroxylapatite crystals may also cause accumulation of an electrostatic charge, due to the pressure and friction exerted by the sponge, facilitating and amplifying the penetration of ions in the enamel structure. A large amount of the nanoparticles of hydroxyapatite could even percolate in the enamel and facilitate a deposition of calcium and calcium phosphate ions on the enamel. The hydroxylapatite may also decrease the deleterious effects of peroxides and allow remineralization of the enamel. Preferably, hydroxyapatite is present in the brightening composition of the present invention at a concentration of about 0.5-5%, or about 1-2% by weight of the composition. In some embodiments, hydroxyapatite particles can comprise aggregates of individual hydroxyapatite particles. For example, such aggregates can have a mean diameter of from about 100 nm to about 1000 nm, and comprise hydroxyapatite particles having a mean diameter of about 10 nm to about 200 nm.

In some embodiments, the brightening composition comprises a stabilizing agent. The stabilizing agent utilized in the aqueous gel is present in an amount ranging from about 0.01% to about 5% by weight of the aqueous gel. An amount of approximately 1% stabilizing agent is preferred. The stabilizing agent is typically selected from aminocarboxylic acids and salts thereof. Preferred stabilizers are selected from aminocarboxylic acids and alkali and/or alkali earth metal salts thereof. Suitable aminocarboxylic acids include trans-1,2-cyclohexylene dinitrilotetraacetic acid (CDTA), ethylenediamine tetraacetic acid (EDTA), N-(2-hydroxyethyl)ethylenediamine triacetic acid (HEDTA), Nitrilotriacetic acid (NTA), diethylene triamine pentaacetic acid (DTPA), triethylene tetraamine hexaacetic acid (TTHA), and ethyleneglycol bis(2-aminoethylether) tetraacetic acid (GEDTA).

In addition to the aforementioned components, a neutralizing agent may be added to the composition. The inorganic and organic neutralizing agents which may be employed are bases. Suitable bases include alkali metal hydroxides and ammonium hydroxide, carbonates, alkoxides, oxides, peroxides, superoxides, and water soluble organic amines. Amino acids such as β-alanine and lysine can also be used for neutralization and viscosity modification. Preferred bases include sodium hydroxide, potassium hydroxide, ammonium hydroxide, triethanolamine (TEA), aminomethyl propanol (AMP), 2-amino-2-hydroxymethyl-1,3-propanediol (Tromethamine), tetrahydroxypropyl ethylenediamine, and tris(hydroxymethyl)aminomethane (TRIS). In certain embodiments, the neutralizing agent will be used to obtain a brightening composition having a pH of about 4 to 10, or about 5 to 7, or about 5.5 to 6.5.

### Example 1

An exemplary brightening composition was prepared by mixing the following components.

| Components | % content |
|---|---|
| Propylene Glycol | ≈16% |
| Purified Water | ≈18% |
| Glycerin | ≈45% |
| Carbamide Peroxide | ≈15% |
| Disodium EDTA | ≈1% |
| CARBOPOL 940 | ≈2% |
| Sodium Hydroxide | ≈0.5% |
| Nano-crystals Hydroxylapatite | ≈1.5% |
| Sodium Saccharine | ≈0.1% |
| Mint Flavoring | ≈0.2% |

1. A device for applying a tooth brightening composition to a tooth, comprising:
a reservoir fluidly connected to an applicator, said applicator having a frictional stress value sufficient to cause mechanical displacement of a biofilm present on a surface of the tooth;
a tooth brightening composition disposed within said reservoir; and
an activator configured to dispense said tooth brightening composition from said reservoir onto an exterior surface of said applicator.

2. A device for applying a tooth brightening composition to a tooth, comprising:
a reservoir fluidly connected to an applicator, said applicator comprising pores having a diameter of 0.1 μm-1000 μm.
a tooth brightening composition disposed within said reservoir; and
an activator configured to dispense said tooth brightening composition from said reservoir onto an exterior surface of said applicator.

3. The device of claim 1, wherein said applicator has a frictional stress value of 0.001 N mm²-3 N mm².

4. The device of claim 1 or 2, wherein said applicator has a contact area of 4 mm² to 100 mm².

5. The device of claim 1 or 2, wherein said applicator comprises a sponge.

6. The device of claim 1 or 2, wherein said tooth brightening composition is present in an amount ranging from 2 ml to 6 ml.

7. The device of claim 1 or 2, wherein said tooth brightening composition comprises a peroxide source.

8. The device of claim 1 or 2, wherein said tooth brightening composition includes hydroxyapatite.

9. The device of claim 8, wherein the hydroxyapatite has a particle size ranging from 10 nm-200 nm.

10. The device of claim 9, wherein the applicator comprises a sponge and the sponge includes pores of sufficient diameter and connectivity for the hydroxyapatite to be transported through the sponge onto an exterior surface of the sponge.

11. The device of claim 1, wherein the applicator comprises pores having a diameter of 0.1 μm-1000 μm.

12. A method for teeth brightening, comprising:
providing a tooth brightening composition disposed within a cylindrical reservoir fluidly connected to an exterior surface of an applicator, said applicator having a frictional stress value sufficient to cause mechanical displacement of a biofilm present on a surface of a tooth, or said applicator comprising pores having a diameter of 0.1 μm-1000 μm, or both;
dispensing said tooth brightening composition through said applicator onto said exterior surface of said applicator; and
applying the tooth brightening composition onto a tooth.

13. The method of claim 12, wherein the tooth brightening composition is applied manually by rubbing said applicator onto said tooth and exerting pressure towards said tooth.

14. (canceled)
